(19) United States
(12) Patent Application Publication
(10) Pub. No.: US 2026/0249388 A1
(43) Pub. Date: Aug. 27, 2026

(54) BEAM-ADJUSTABLE LASER-ASSISTED TURNING DEVICE AND MACHINING METHOD

(71) Applicant: SHANDONG UNIVERSITY, Jinan (CN)

(72) Inventors: Yukui CAI, Jinan (CN); Di DAI, Jinan (CN); Shihai SUN, Jinan (CN); Xiaoliang LIANG, Jinan (CN); Xing LI, Jinan (CN); Yunqing TANG, Jinan (CN); Jilai WANG, Jinan (CN); Quhao LI, Jinan (CN); Zhanqiang LIU, Jinan (CN)

(21) Appl. No.: 19/449,824

(22) Filed: Jan. 15, 2026

(30) Foreign Application Priority Data
Feb. 24, 2025 (CN) 2025102046489

(51) Int. Cl. B23K 26/08; B23K 26/064

(52) U.S. Cl. CPC B23K 26/0876; B23K 26/0648

(57) ABSTRACT

A beam-adjustable laser-assisted turning device, wherein a lathe X/Y-axis moving platform is fixed above a lathe moving guide rail; a lathe tool changing and positioning table is fixed above and on a side of lathe X/Y-axis moving platform; a beam-adjustable turning tool module is fixed on a side of lathe tool changing and positioning table; a beam fixing module is fixed above lathe X/Y-axis moving platform and on a side of lathe tool changing and positioning table; a laser beam emission module is fixed on a side of lathe tool changing and positioning table and beam-adjustable turning tool module through beam fixing module, and a laser emission port is maintained in a coaxial position with a laser beam directional hole; and a modulatable laser generator is fixed on a side of lathe bed and connected to a beam receiving port of laser beam emission module through a laser fiber.

### CROSS-REFERENCE TO RELATED APPLICATIONS

The present invention claims priority to Chinese Patent Application No. 202510204648.9, filed with the China National Intellectual Property Administration on Feb. 24, 2025, entitled “BEAM-ADJUSTABLE LASER-ASSISTED TURNING DEVICE AND MACHINING METHOD”, the entire content of which is incorporated herein by reference and constitutes part of the present invention for all purposes.

### TECHNICAL FIELD

The present invention belongs to the field of turning, and in particular relates to a beam-adjustable laser-assisted turning device and a machining method.

### BACKGROUND

Laser-assisted machining technology is a novel machining method developed in recent years, which is widely applied in the field of high-precision and high-quality manufacturing, aiming to solve the problems such as cracks, surface damage and severe tool wear caused by the hard and brittle characteristics of materials. Its core principle is to combine laser beams with traditional cutting methods such as turning, milling, grinding, and drilling. By virtue of the high energy density and precise positioning effect of laser beams, the yield strength of materials is reduced and the plasticity is enhanced, so as to achieve plastic removal of difficult-to-machine materials, and reduce tool wear as well as surface and subsurface damage of workpieces. This technology can not only effectively improve the mechanical properties and surface roughness of difficult-to-machine materials, but also has important application value especially in the fields of micro-machining, machining of complex curved surfaces, and machining of difficult-to-machine materials such as superalloys and ceramics.

At present, laser-assisted machining technology and the relevant equipment currently in use are still faced with several problems, which are specified as follows:

Problem I: Laser beam regulation issue. Traditional Gaussian laser beams feature a fixed size and an energy distribution pattern of extremely high intensity in the center and extremely low intensity at the edges. This uneven thermal effect gives rise to thermal deformation and thermal damage. In the prior art, adjustments to the laser beam size are generally achieved by modifying the position of the laser emission port relative to the workpiece irradiation surface or replacing the laser device type. However, the first adjustment method is difficult to implement and offers poor flexibility in regulating the spot size; the second method of replacing the laser device type incurs high costs.

Problem II: Integration issue between laser and turning systems. Most integration methods of laser and turning systems involve fixing the laser beam emission module above or on the side of the machine tool bed (refer to Patent CN107234444A for details). The laser beam is at a certain angle relative to the turning tool, which limits the safe machining area and increases machining risks.

### SUMMARY

To address the two technical problems existing in the above background art, an objective of the present invention is to provide a beam-adjustable laser-assisted turning device and a machining method thereof. In this method, a beam-adjustable turning tool module and a beam fixing module are designed. By utilizing the beam regulation capability of a detachable collimating lens and the laser beam positioning capability of the beam fixing module, the laser beam is directed to pass through a turning tool and continuously irradiate the to-be-machined area of a workpiece.

To achieve the above objective, the technical solutions adopted by the present invention are as follows:

In a first aspect, the present invention provides a beam-adjustable laser-assisted turning device, including a lathe X/Y-axis moving platform, a lathe tool changing and positioning table, a beam-adjustable turning tool module, a beam fixing module, a laser beam emission module, and a modulatable laser generator;
the lathe tool changing and positioning table is fixed at a position above and on a side of the lathe X/Y-axis moving platform;
the beam-adjustable turning tool module is fixed on a side of the lathe tool changing and positioning table; and the beam-adjustable turning tool module is provided with a turning tool insert, a laser beam directional hole, and the laser beam emission module;
the beam fixing module is fixed above the lathe X/Y-axis moving platform and on a side of the lathe tool changing and positioning table;
the laser beam emission module is fixed on a side of the lathe tool changing and positioning table and the beam-adjustable turning tool module via the beam fixing module, and a laser emission port of the laser beam emission module is maintained in a coaxial position with the laser beam directional hole to achieve a function of coaxial transmission of a laser beam; and
the modulatable laser generator is connected to a beam receiving port of the laser beam emission module through a laser fiber to achieve a function of laser beam input.

As a further technical solution, the beam-adjustable turning tool module includes a detachable turning tool insert, an insert fixing pressure plate, a turning tool shank, the laser beam directional hole, a beam regulation lens mounting internal groove, a detachable collimating lens, and a collimating lens mounting plate; the detachable turning tool insert is mounted on the insert fixing pressure plate; the insert fixing pressure plate is mounted on an upper side of the turning tool shank; the laser beam directional hole is located at a front end of the turning tool shank; and the detachable collimating lens is fixed on an inner side of the collimating lens mounting plate by means of flexible bonding, and the collimating lens mounting plate is fixed in the beam regulation lens mounting internal groove of the turning tool shank via clearance fit to achieve a function of laser beam regulation. The present invention achieves laser heat sources with different spot sizes and different energy distributions by adding auxiliary light field regulation means to the laser transmission path outside the laser device, designing the turning tool shank at the same time, and replacing the original collimating lens with the collimating lens having laser beam regulation capability.

As a further technical solution, the turning tool shank is mounted on a side of the lathe tool changing and positioning table.

As a further technical solution, a position of the turning tool shank on the lathe tool changing and positioning table is adjustable.

As a further technical solution, the turning tool shank includes a shank body, and a front end of the shank body protrudes laterally to form a front mounting portion; and the detachable turning tool insert is mounted at a corner position of the front mounting portion, the beam regulation lens mounting internal groove is disposed in an interior of the front mounting portion, and the beam regulation lens mounting internal groove penetrates a side surface of the shank body, so that the collimating lens mounting plate is capable of being inserted into the beam regulation lens mounting internal groove from the side surface of the shank body to an interior of the shank body, and a laser beam directional hole is disposed on the front mounting portion, and the laser beam directional hole allows a laser emitted by the laser beam emission module to pass through the collimating lens.

As a further technical solution, the collimating lens mounting plate is provided with a mounting hole, and the detachable collimating lens is mounted within the mounting hole.

As a further technical solution, the beam fixing module includes a fixed base, a rotating platform, a jaw connecting arm, a jaw guide rail, a jaw moving slider, a clamping jaw, an angle adjustment bolt, a compression and positioning bolt, and a connecting bearing; the fixed base is fixed above the lathe X/Y-axis moving platform; the rotating platform is connected to the fixed base via the connecting bearing to achieve a function of angle adjustment by rotating around a Z-axis direction; the jaw connecting arm is connected to the rotating platform via the angle adjustment bolt to achieve a function of angle adjustment by rotating around a Y-axis direction; the jaw guide rail is fixed on a side of the jaw connecting arm; the jaw moving slider is mounted on an inner side of the jaw guide rail by means of mechanical clearance fit; the clamping jaw is connected to the jaw moving slider to achieve a function of a clamping jaw position being adjustable; and the clamping jaw achieves a function of positioning the laser beam emission module by clamping a lens group protective housing.

As a further technical solution, the beam-adjustable turning tool module is maintained in a certain relative position with the laser beam emission module via the beam fixing module; a laser generated by the modulatable laser generator is transmitted to the laser beam emission module via the laser fiber; the laser is emitted from the laser emission port to the detachable collimating lens to achieve a function of laser beam shape regulation; and a regulated laser beam passes through the laser beam directional hole located at the front end of the turning tool shank to achieve a function of directional irradiation of a turning area by the laser beam.

In a second aspect, based on the above beam-adjustable laser-assisted turning device, the present invention discloses a machining method, including steps of:
step 1: clamping a workpiece on a machine tool chuck, starting a lathe motion control system, a lathe moving guide rail, and the lathe X/Y-axis moving platform, and setting initial system parameter values and an initial position;
step 2: fixing the detachable collimating lens on the collimating lens mounting plate, and fixing the collimating lens mounting plate in the beam regulation lens mounting internal groove;
step 3: mounting and fixing the beam-adjustable turning tool module on the lathe tool changing and positioning table, and mounting the beam fixing module to fix the laser beam emission module, so that the beam-adjustable turning tool module is maintained in a certain relative position with the laser beam emission module;
step 4: connecting the laser beam emission module and the modulatable laser generator by using the laser fiber; and
step 5: performing a workpiece and tool positioning operation before machining, and simultaneously running a machining program and the modulatable laser generator to complete laser-assisted turning.

The beneficial effects of the present invention are as follows:

The laser beam generated by the modulatable laser generator can be directly transmitted to the laser beam emission module via the laser fiber. The laser beam emission module is fixed on the side of the lathe X/Y-axis moving platform by the beam fixing module, which avoids occupying the area required for normal machining of the machine tool, reduces the machining risk level, and enables rapid adjustment of “the relative position between the laser emission module and the beam-adjustable turning tool module.” Meanwhile, in cooperation with the beam-adjustable turning tool module, which includes a turning tool shank with a laser beam directional hole and a beam collimation regulation device, the laser beam directional hole and the beam regulation lens mounting internal groove are arranged inside the turning tool shank. By replacing the original collimating lens with the collimating lens having laser beam shaping capability, laser heat sources with different spot sizes and different energy distributions are achieved, thereby realizing the machining effect of “laser beam regulation and continuous irradiation of the to-be-machined area.” For the beam-adjustable laser-assisted turning device, the structure is simple, and the machining operation is convenient, allowing for quick replacement of machining materials, turning tools and laser machining equipment, which can meet the requirements for high-quality and high-efficiency machining of cylindrical workpieces made of metallic and non-metallic materials.

### BRIEF DESCRIPTION OF THE DRAWINGS

FIG. 1 is a schematic diagram of an overall structure of a novel beam-adjustable laser-assisted turning device according to the present invention.

FIG. 2 is a schematic diagram of a beam-adjustable turning tool module as well as a turning tool shank and a laser beam directional hole included.

FIG. 3 is a schematic diagram of a beam collimation regulation device included in a beam-adjustable turning tool module.

FIG. 4 is a schematic diagram of assembly of a beam fixing module and a laser beam emission module.

FIG. 5 is a top view schematic diagram of a novel beam-adjustable laser-assisted turning device according to the present invention.

In the figures: 1. lathe motion control system, 2. lathe bed, 3. lathe moving guide rail, 4. lathe X/Y-axis moving platform, 5. lathe tool changing and positioning table, 6. beam-adjustable turning tool module, 7. beam fixing module, 8. laser beam emission module, 9. modulatable laser generator, 10. laser transmission fiber, 401. X-axis moving platform, 402. Y-axis moving platform, 501. tool fastening and positioning bolt, 502. positioning and compression threaded hole, 503. tool changing table positioning hole, 601. detachable turning tool insert, 602. turning tool insert fastening screw, 603. insert fixing pressure plate, 604. pressure plate fastening screw, 605. turning tool shank, 606. laser beam directional hole, 607. beam regulation lens mounting internal groove, 608. detachable collimating lens, 609. collimating lens mounting plate, 701. fixed base, 702. rotating platform, 703. jaw connecting arm, 704. jaw guide rail, 705. jaw moving slider, 706. clamping jaw, 707. angle adjustment bolt, 708. compression and positioning bolt, 709. connecting bearing, 710. fastening screw, 801. laser emission port, 802. beam receiving port, 803. lens group protective housing, and 901. external touch control screen.

### DETAILED DESCRIPTION

The implementations are further described below in conjunction with the drawings and examples.

It should be noted that the following detailed descriptions are all exemplary and are intended to provide further explanations of the present invention. Unless otherwise specified, all technical and scientific terms used herein have the same meaning as commonly understood by those of ordinary skill in the art to which the present invention belongs.

Provided is a beam-adjustable laser-assisted turning device, and a machining principle thereof is as follows: the workpiece to be machined is fixed at a position of a machine tool chuck; a laser emission module is fixed by jaws of a beam fixing module and is maintained in a certain relative position with a specially designed turning tool; and a laser beam is regulated by a collimating lens, passes through a laser beam directional hole and irradiates a to-be-cut area of the workpiece, thereby achieving the effect of synchronous turning and laser-assisted heating machining. Through this novel laser-assisted turning device that can not only achieve laser beam regulation but also realize synchronous operation of a laser and a cutting tool, while avoiding occupying an internal space of the machine tool, the precision of laser-assisted turning will be greatly improved, the machining risk level will be reduced, and the better adaptability of the device to different machining tasks and material types will be further enhanced.

### Example 1

The machined object selected in the present example is a cylindrical silicon carbide blank rod, which is characterized as follows: it is made of a hard and brittle ceramic material, with poor outer surface flatness and high surface roughness. For practical application, the outer surface shall be subjected to blank removal treatment. Turning is selected as the machining method. Due to the inherent hard and brittle characteristics of the material, the laser is required not only to continuously irradiate the to-be-cut area of the workpiece during the turning process, but also to achieve uniform irradiation of laser energy. This prevents thermal damage caused by excessive energy concentration-induced thermal effects, and aims to achieve uniform preheating and softening of the material in the to-be-cut area. Meanwhile, it is needed to prevent the laser machining equipment from occupying the area required for normal machining of the machine tool and to avoid laser irradiation on the cutting tool. To address the above problems, it is necessary to specially develop a novel turning tool module with functions of beam adjustability and directional laser beam irradiation guidance, as well as a beam fixing module that meets the assembly requirements of a turning tool module and a laser emission module. Therefore, the present invention proposes a novel beam-adjustable laser-assisted turning device and machining method. A specific implementation method is as follows:

As shown in FIG. 1, the beam-adjustable laser-assisted turning device proposed in the present example includes a lathe motion control system 1, a lathe bed 2, a lathe moving guide rail 3, a lathe X/Y-axis moving platform 4, a lathe tool changing and positioning table 5, a beam-adjustable turning tool module 6, a beam fixing module 7, a laser beam emission module 8, a modulatable laser generator 9, and a laser transmission fiber 10.

The lathe motion control system 1 is mechanically assembled with the lathe bed 2, lathe moving guide rail 3, and lathe X/Y-axis moving platform 4 to form a high-precision turning system. The lathe X/Y-axis moving platform 4 is fixed above the lathe moving guide rail 3 to achieve high-precision machining of the workpiece in an X-axis direction. The lathe tool changing and positioning table 5 is fixed on an upper side of a Y-axis moving platform 402 of the lathe X/Y-axis moving platform 4, enabling high-precision machining of the workpiece in a Y-axis direction. The beam-adjustable turning tool module 6 is fixed on a side of the lathe tool changing and positioning table 5 through cooperation of a tool fastening and positioning bolt 501 and a positioning and compression threaded hole 502, and multi-position positioning of the beam-adjustable turning tool module 6 can be achieved by adjusting a mounting position of the tool fastening and positioning bolt 501. Specifically, a plurality of bolt holes are disposed on the lathe tool changing and positioning table 5, and a plurality of connecting holes are disposed on the beam-adjustable turning tool module 6. When it is necessary to adjust a position of the beam-adjustable turning tool module 6, the position of the beam-adjustable turning tool module 6 is first moved, and then the tool fastening and positioning bolt 501 at a corresponding position is connected to the beam-adjustable turning tool module 6. The beam fixing module 7 is fixed above an X-axis moving platform 401 of the lathe X/Y-axis moving platform 4 and on a side of the lathe tool changing and positioning table 5 through via a compression and positioning bolt 708. The laser beam emission module 8 is fixed on a side of the lathe tool changing and positioning table 5 and the beam-adjustable turning tool module 6 via the beam fixing module 7, and the laser emission port 801 is maintained in a coaxial position with the laser beam directional hole 606 to achieve a function of coaxial transmission of a laser beam. The modulatable laser generator 9 is fixed on a side of the lathe bed 2, and is connected to a beam receiving port 802 of the laser beam emission module 8 via the laser fiber 10 to achieve a function of laser beam input.

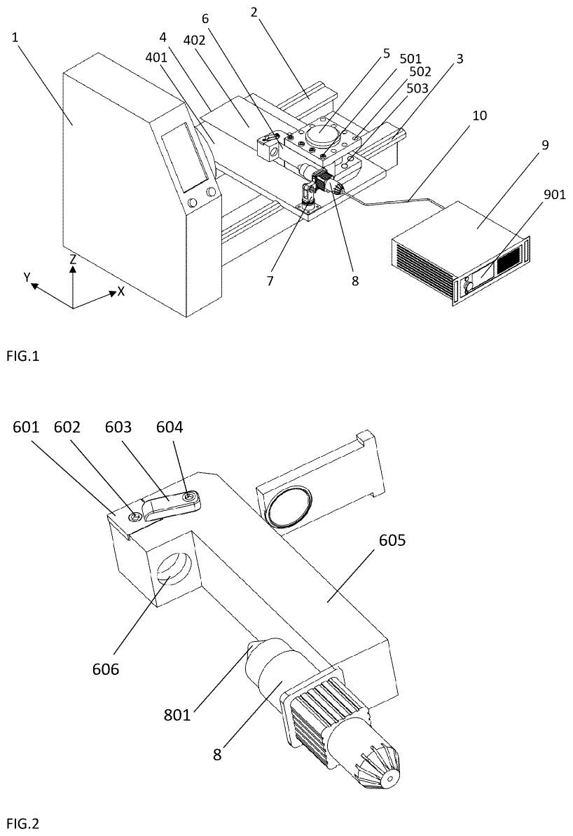

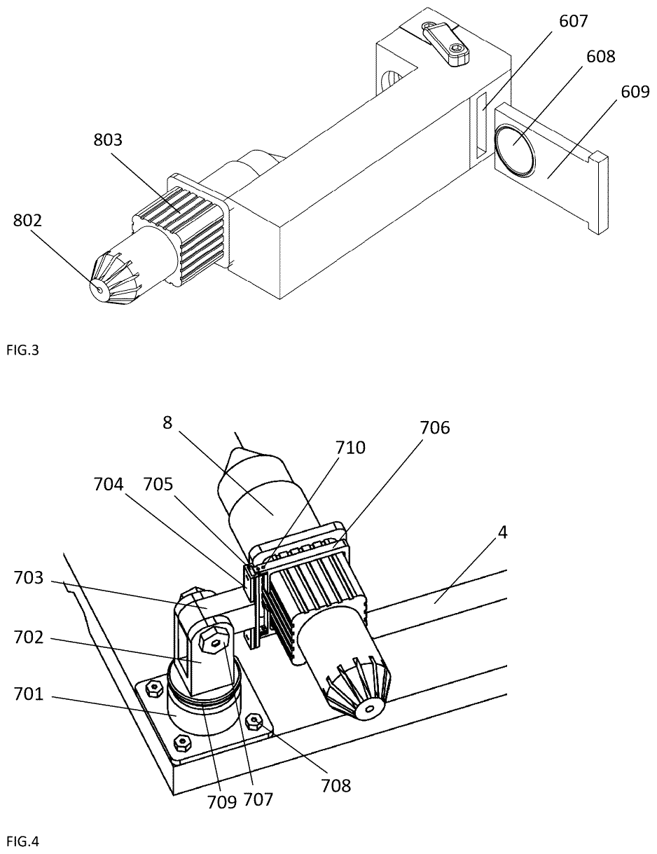

As shown in FIGS. 2 and 3, the beam-adjustable turning tool module 6 includes a detachable turning tool insert 601, a turning tool insert fastening screw 602, an insert fixing pressure plate 603, a pressure plate fastening screw 604, a turning tool shank 605, a laser beam directional hole 606, a beam regulation lens mounting internal groove 607, a detachable collimating lens 608, and a collimating lens mounting plate 609.

The detachable turning tool insert 601 is fixed to the insert fixing pressure plate 603 via the turning tool insert fastening screw 602 to achieve a function of turning tool insert positioning. The insert fixing pressure plate 603 is fixed on an upper side of the turning tool shank 605 via the pressure plate fastening screw 604. The laser beam directional hole 606 is located at a front end of the turning tool shank 605 to achieve a function of directional laser beam irradiation. The detachable collimating lens 608 is fixed on an inner side of the collimating lens mounting plate 609 by means of flexible bonding, enabling the replaceable function of the collimating lens 608. The collimating lens mounting plate 609 is fixed in the beam regulation lens mounting internal groove 607 of the turning tool shank 605 via clearance fit to achieve a function of laser beam regulation.

Further, the turning tool shank 605 includes a shank body. A front end of the shank body protrudes laterally to form a front mounting portion for the detachable turning tool insert 601 and the collimating lens mounting plate 609. The detachable turning tool insert 601 is mounted at a corner position of the front mounting portion, the beam regulation lens mounting internal groove 607 is disposed in an interior of the front mounting portion, and the beam regulation lens mounting internal groove 607 penetrates a side surface of the shank body, so that the collimating lens mounting plate 609 is capable of being inserted into the beam regulation lens mounting internal groove 607 from the side surface of the shank body to an interior of the shank body, and a laser beam directional hole is disposed on the front mounting portion, and the laser beam directional hole allows light emitted by the laser beam emission module to pass through the collimating lens 608. In the present example, by disposing the beam regulation lens mounting internal groove 607 on the shank body, the collimating lens mounting plate 609 can be quickly disassembled and mounted as needed, thereby facilitating replacement of the collimating lens 608. Specifically, when it is necessary to adjust the spot size of the laser, there is no need to replace the laser device; it is only required to disassemble the collimating lens mounting plate 609, then remove the collimating lens on the collimating lens mounting plate 609, and replace it with another collimating lens of a different size. In addition, by adopting the collimating lens, the present invention ensures that within a certain distance range, even if the shank is moved, the spot size and laser energy distribution will not be affected.

Further, the laser beam emission module 8 includes a laser emission port 801, a beam receiving port 802, and a lens group protective housing 803. The beam receiving port 802 receives a laser beam transmitted by the modulatable laser generator 9 via the laser fiber 10; and the laser emission port 801 is configured to emit a laser into the detachable collimating lens 608.

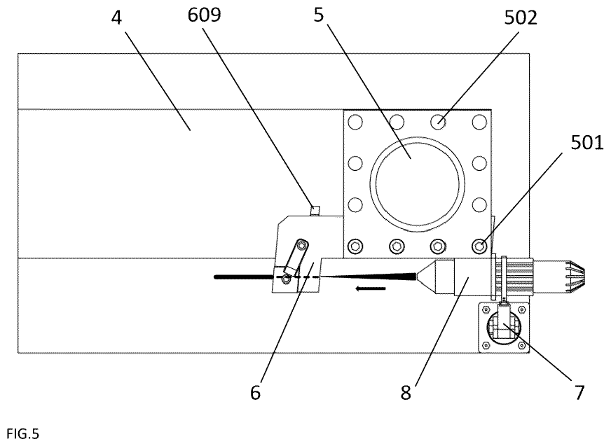

As shown in FIGS. 4 and 5, the lathe X/Y-axis moving platform 4 includes the X-axis moving platform 401 and the Y-axis moving platform 402, which can achieve the controlled movement of the beam-adjustable turning tool module 6 and the laser beam emission module 8 in the X-axis and Y-axis directions.

Further, a bottom of the lathe tool changing and positioning table 5 is provided with a tool changing table positioning hole 503 connected to the Y-axis moving platform 402, and a position of the lathe tool changing and positioning table 5 is fixed via the positioning hole. A positioning and compression threaded hole 502 is disposed at an upper portion of the lathe tool changing and positioning table 5. By adjusting an assembly position of the tool fastening and positioning bolt 501, a positioning function of the beam-adjustable turning tool module 6 is achieved.

Further, the beam fixing module 7 is configured to fix a position of the laser beam emission module 8, and includes a fixed base 701, a rotating platform 702, a jaw connecting arm 703, a jaw guide rail 704, a jaw moving slider 705, a clamping jaw 706, an angle adjustment bolt 707, a compression and positioning bolt 708, a connecting bearing 709, and a fastening screw 710. The fixed base 701 is fixed above the lathe X/Y-axis moving platform 4 via the compression and positioning bolt 708. The rotating platform 702 is connected to the fixed base 701 via the connecting bearing 709 to achieve a function of angle adjustment by rotating around a Z-axis direction. The jaw connecting arm 703 is connected to the rotating platform 702 via the angle adjustment bolt 707 to achieve a function of angle adjustment by rotating around a Y-axis direction. The jaw guide rail 704 is fixed on a side of the jaw connecting arm 703 via the fastening screw 710. The jaw moving slider 705 is mounted on an inner side of the jaw guide rail 704 by means of mechanical clearance fit. The clamping jaw 706 is connected to the jaw moving slider 705 via the fastening screw 710 to achieve a function of a position of the clamping jaw 706 being adjustable. The clamping jaw 706 achieves a function of positioning the laser beam emission module 8 by clamping the lens group protective housing 803.

Further, it should be noted that the above collimating lens can be replaced with lenses of different models to achieve adjustment of different spot sizes. This allows the present invention to adjust the spot size without replacing the laser device. In addition, by adopting the collimating lens, the present invention ensures that within a certain distance range, even if the shank is moved, the spot size and laser energy distribution will not be affected.

Further, the machining method for the beam-adjustable laser-assisted turning device proposed in the present example includes steps of:
step 1: clamping a cylindrical silicon carbide blank workpiece on a machine tool chuck, starting a lathe motion control system 1, a lathe moving guide rail 3, and the lathe X/Y-axis moving platform, and setting initial system parameter values and an initial position;
step 2: fixing the detachable collimating lens 608 on the collimating lens mounting plate 609, and fixing the collimating lens mounting plate 609 in the beam regulation lens mounting internal groove 607;
step 3: mounting and fixing the beam-adjustable turning tool module 6 on the lathe tool changing and positioning table 5, and mounting the beam fixing module 7 to fix the laser beam emission module 8, so that the beam-adjustable turning tool module 6 is maintained in a certain relative position with the laser beam emission module 8;
step 4: connecting the laser beam emission module 8 and the modulatable laser generator 9 by using the laser fiber 10; and
step 5: performing a workpiece and tool positioning operation before machining, and simultaneously running a machining program and the modulatable laser generator 9 to complete laser-assisted turning, thereby achieving a purpose of high-quality and high-efficiency blank removal.

Matters not covered herein of the present invention are well-known technologies in the art.

The above embodiment is merely intended to illustrate the technical concept and features of the present invention, and its purpose is to enable those skilled in the art to understand the content of the present invention and implement it accordingly, but shall not be construed as limiting the scope of protection of the present invention. Any equivalent changes or modifications made in accordance with the spirit and essence of the present invention shall fall within the scope of protection of the present invention.

1. A beam-adjustable laser-assisted turning device, comprising a lathe X/Y-axis moving platform, a lathe tool changing and positioning table, a beam-adjustable turning tool module, a beam fixing module, a laser beam emission module, and a modulatable laser generator;
wherein the lathe tool changing and positioning table is fixed at a position above and on a side of the lathe X/Y-axis moving platform;
the beam-adjustable turning tool module is fixed on a side of the lathe tool changing and positioning table; and the beam-adjustable turning tool module is provided with a turning tool insert, a laser beam directional hole, and the laser beam emission module;
the beam fixing module is fixed above the lathe X/Y-axis moving platform and on a side of the lathe tool changing and positioning table;
the laser beam emission module is fixed on a side of the lathe tool changing and positioning table and the beam-adjustable turning tool module via the beam fixing module, and a laser emission port of the laser beam emission module is maintained in a coaxial position with the laser beam directional hole to achieve a function of coaxial transmission of a laser beam;
the modulatable laser generator is connected to a beam receiving port of the laser beam emission module through a laser fiber to achieve a function of laser beam input;
the beam-adjustable turning tool module comprises a detachable turning tool insert, an insert fixing pressure plate, a turning tool shank, the laser beam directional hole, a beam regulation lens mounting internal groove, a detachable collimating lens, and a collimating lens mounting plate; the detachable turning tool insert is mounted on the insert fixing pressure plate; the insert fixing pressure plate is mounted on an upper side of the turning tool shank; the laser beam directional hole is located at a front end of the turning tool shank; and the detachable collimating lens is fixed on an inner side of the collimating lens mounting plate by means of flexible bonding, and the collimating lens mounting plate is fixed in the beam regulation lens mounting internal groove of the turning tool shank via clearance fit to achieve a function of laser beam regulation; and
the turning tool shank comprises a shank body, and a front end of the shank body protrudes laterally to form a front mounting portion; and the detachable turning tool insert is mounted at a corner position of the front mounting portion, the beam regulation lens mounting internal groove is disposed in an interior of the front mounting portion, and the beam regulation lens mounting internal groove penetrates a side surface of the shank body, so that the collimating lens mounting plate is capable of being inserted into the beam regulation lens mounting internal groove from the side surface of the shank body to an interior of the shank body, and a laser beam directional hole is disposed on the front mounting portion, and the laser beam directional hole allows a laser emitted by the laser beam emission module to pass through the collimating lens.

2. The beam-adjustable laser-assisted turning device according to claim 1, wherein the turning tool shank is mounted on a side of the lathe tool changing and positioning table.

3. The beam-adjustable laser-assisted turning device according to claim 2, wherein a position of the turning tool shank on the lathe tool changing and positioning table is adjustable.

4. The beam-adjustable laser-assisted turning device according to claim 1, wherein the collimating lens mounting plate is provided with a mounting hole, and the detachable collimating lens is mounted within the mounting hole.

5. The beam-adjustable laser-assisted turning device according to claim 1, wherein the beam fixing module comprises a fixed base, a rotating platform, a jaw connecting arm, a jaw guide rail, a jaw moving slider, a clamping jaw, an angle adjustment bolt, a compression and positioning bolt, and a connecting bearing; the fixed base is fixed above the lathe X/Y-axis moving platform; the rotating platform is connected to the fixed base via the connecting bearing to achieve a function of angle adjustment by rotating around a Z-axis direction; the jaw connecting arm is connected to the rotating platform via the angle adjustment bolt to achieve a function of angle adjustment by rotating around a Y-axis direction; the jaw guide rail is fixed on a side of the jaw connecting arm; the jaw moving slider is mounted on an inner side of the jaw guide rail by means of mechanical clearance fit; the clamping jaw is connected to the jaw moving slider to achieve a function of a clamping jaw position being adjustable; and the clamping jaw achieves a function of positioning the laser beam emission module by clamping a lens group protective housing.

6. The beam-adjustable laser-assisted turning device according to claim 1, wherein the beam-adjustable turning tool module is maintained in a certain relative position with the laser beam emission module via the beam fixing module.

7. The beam-adjustable laser-assisted turning device according to claim 1, wherein a laser generated by the modulatable laser generator is transmitted to the laser beam emission module via the laser fiber; the laser is emitted from the laser emission port to the detachable collimating lens to achieve a function of laser beam shape regulation; and a regulated laser beam passes through the laser beam directional hole located at the front end of the turning tool shank to achieve a function of directional irradiation of a turning area by the laser beam.

8. A machining method for the beam-adjustable laser-assisted turning device according to claim 1, comprising steps of:
step 1: clamping a workpiece on a machine tool chuck, starting a lathe motion control system, a lathe moving guide rail, and the lathe X/Y-axis moving platform, and setting initial system parameter values and an initial position;
step 2: fixing the detachable collimating lens on the collimating lens mounting plate, and fixing the collimating lens mounting plate in the beam regulation lens mounting internal groove;
step 3: mounting and fixing the beam-adjustable turning tool module on the lathe tool changing and positioning table, and mounting the beam fixing module to fix the laser beam emission module, so that the beam-adjustable turning tool module is maintained in a certain relative position with the laser beam emission module;
step 4: connecting the laser beam emission module and the modulatable laser generator by using the laser fiber; and
step 5: performing a workpiece and tool positioning operation before machining, and simultaneously running a machining program and the modulatable laser generator to complete laser-assisted turning.
